(19) United States
(12) Patent Application Publication
(10) Pub. No.: US 2025/0193736 A1
(43) Pub. Date: Jun. 12, 2025

(54) COMMUNICATION SYSTEM

(71) Applicant: TOYOTA JIDOSHA KABUSHIKI KAISHA, Toyota-shi (JP)

(72) Inventors: Mitsuhiro ONO, Yokosuka-shi (JP); Kazumi TAKEUCHI, Uji-shi (JP)

(73) Assignee: TOYOTA JIDOSHA KABUSHIKI KAISHA, Toyota-shi (JP)

(21) Appl. No.: 18/973,845

(22) Filed: Dec. 9, 2024

(30) Foreign Application Priority Data
Dec. 11, 2023 (JP) 2023-208737

(51) Int. Cl. H04W 28/08; H04W 4/44; H04W 48/10

(52) U.S. Cl. CPC H04W 28/08; H04W 4/44; H04W 48/10

(57) ABSTRACT

The communication system includes a communication device mounted on a vehicle, a load balancer, and a plurality of distribution systems. The communication device transmits a vehicle message indicating the connection request to the load balancer. The load balancer determines whether to transfer the vehicle message to one distribution system of the plurality of distribution systems based on the setting parameters related to the vehicle message. If it is determined to forward the vehicle message to one distribution system, the one distribution system sends a reply message to the vehicle message.

### CROSS-REFERENCE TO RELATED APPLICATION

This application claims priority to Japanese Patent Application No. 2023-208737 filed on Dec. 11, 2023, incorporated herein by reference in its entirety.

### BACKGROUND

### 1. Technical Field

The present disclosure relates to a technical field of a communication system that transmits and receives information to and from a vehicle.

### 2. Description of Related Art

As a system of this type, for example, a system for collecting vehicle data from a vehicle has been proposed (see Japanese Unexamined Patent Application Publication No. 2016-132368 (JP 2016-132368 A)).

### SUMMARY

This type of system has a technical problem, for example, in that complex control is often required in a redundant configuration for constantly enabling communication with a vehicle.

The present disclosure has been made in view of the above problem, and an object of the present disclosure is to provide a communication system capable of constantly performing communication with a vehicle by relatively simple control.

A communication system according to an aspect of the present disclosure includes:
a communication device mounted on a vehicle;
a load balancer; and
a plurality of distribution systems.
   The communication device is configured to transmit a vehicle message indicating a connection request to the load balancer.
   The load balancer is configured to determine whether to transfer the vehicle message to one distribution system out of the plurality of distribution systems based on a setting parameter related to the vehicle message.
   The one distribution system is configured to, when determination is made to transfer the vehicle message to the one distribution system, transmit a reply message to the vehicle message.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram illustrating a configuration of a communication system according to an embodiment; and

FIG. 2 is a flowchart illustrating an operation of the communication system according to the embodiment.

### DETAILED DESCRIPTION OF EMBODIMENTS

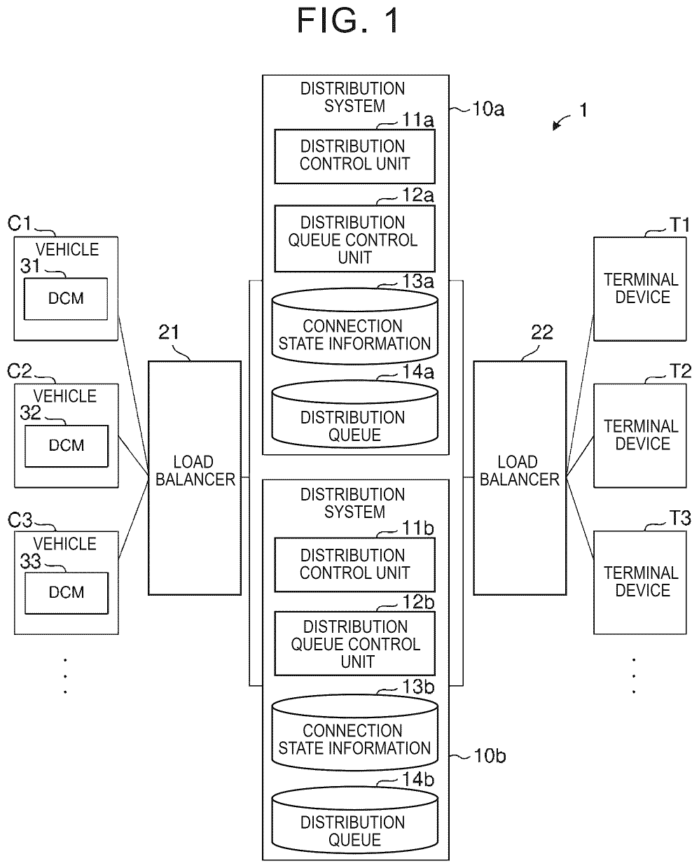

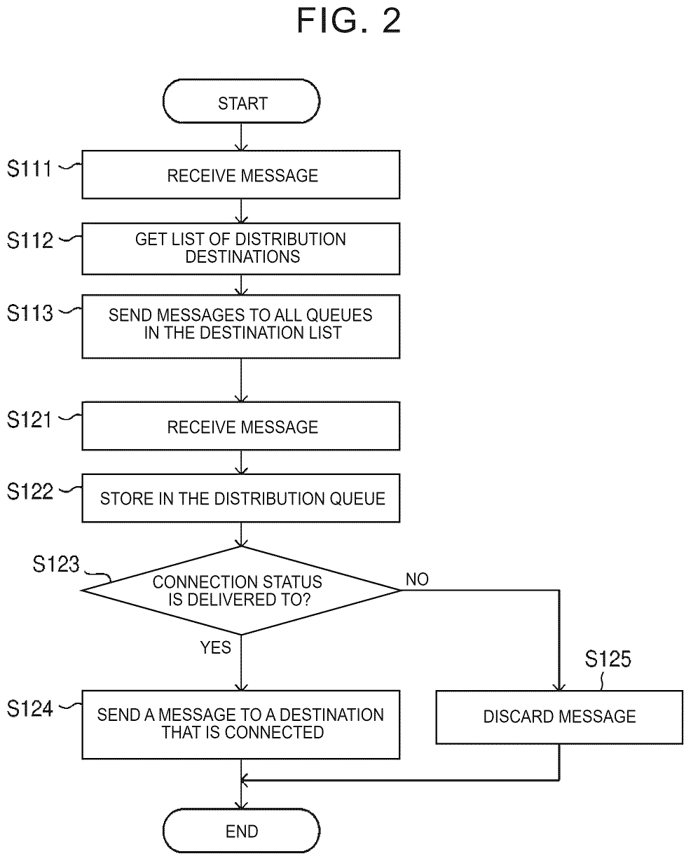

An embodiment of a communication system will be described with reference to FIGS. 1 and 2. In FIG. 1, the communication system 1 includes a distribution system 10a and 10b, load balancers 21 and 22, DCM (Data Communication Module) 31, 32, and 33, and a terminal device T1, T2 and a T3. DCM 31, 32, and 33 are mounted on C1, C2 and C3, respectively.

The communication system 1 may include three or more distribution systems. The communication system 1 may include four or more DCM. Alternatively, the communication system 1 may comprise one or two of DCM 31, 32 and 33. The communication system 1 may include four or more terminal devices. Alternatively, the communication system may include one or two of the terminal device T1, T2 and T3.

The distribution system 10a and 10b and the load balancers 21 and 22 are connected to a wide area network such as the Internet. DCM 31, 32 and 33 are connected to the wide area network, for example, via a radio base station. Thus, the vehicles C1, C2 and C3 may be connected cars. The terminal device T1, T2 and T3 are connected to the wide area network through, for example, a radio base station or a communication cable.

For example, the communication system 1 may form part of an information infrastructure for a connected car. For example, it is assumed that the user of the vehicle 31 possesses the terminal device T1. A user of the vehicle 31 may transmit a message indicating a destination to the vehicle 31 using a message application installed in the terminal device T1. The message transmitted from the terminal device T1 is transmitted to the vehicle 31 via the load balancer 22, at least one of the distribution systems 10a and 10b, and the load balancer 21. Upon receiving the message, the vehicle 31 may set the destination indicated by the received message at the destination of the navigation device. The message application may be referred to as a talk application or a chat application, for example.

The location where the distribution system 10a is installed and the location where the distribution system 10b is installed may be geographically separated. For example, in Japan, the distribution system 10a may be installed at a base existing in eastern Japan, and the distribution system 10b may be installed at a base existing in western Japan.

The vehicle messages transmitted from DCM 31, 32, and 33 to the outside of the vehicle may be assigned position information regarding the positions of DCM 31, 32, and 33 (in other words, the positions of the vehicle C1, C2 and C3), respectively.

The load balancer 21 forwards the vehicle message to at least one of the distribution systems 10a and 10b. At this time, the load balancer 21 may transmit the vehicle message to at least one of the distribution systems 10a and 10b according to a predetermined setting. The load balancer 21 may determine whether to transmit the vehicle message to the distribution system 10a based on the predetermined setting. Similarly, the load balancer 21 may determine whether to send a vehicle message to the distribution system 10b based on a predetermined setting. The predetermined setting may comprise selecting a distribution system close to the location of DCM (in other words, the location of the vehicle). The predetermined setting may be stored in the load balancer 21 as a setting parameter.

For example, it is assumed that the distribution system 10a is installed at a base existing in East Japan, and the distribution system 10b is installed at a base existing in West Japan. The load balancer 21 may forward the vehicle messages sent from DCM 31 to the distribution system 10a when DCM 31 (that is, vehicle C1) exists in Tokyo. In other words, the position information regarding the position “Tokyo” may be assigned to the vehicle message transmitted from DCM 31. The load balancer 21 may select the distribution system 10a as the forwarding destination of the vehicle messaging, for example, based on a setting of “selecting a distribution system close to the location of DCM”.

Alternatively, if DCM 31 is present in Osaka, the load balancer 21 may forward the vehicle message sent from DCM 31 to the distribution system 10b. In other words, the position information regarding the position “Osaka” may be assigned to the vehicle message transmitted from DCM 31. The load balancer 21 may select the distribution system 10b as the forwarding destination of the vehicle messaging, for example, based on a setting of “selecting a distribution system close to the location of DCM”.

Even when DCM 31 is present in Osaka, the load balancer 21 may transmit the vehicle message transmitted from DCM 31 to the distribution system 10a when the load of the distribution system 10b is significantly higher than the load of the distribution system 10a.

The terminal device T1, T2 and the terminal message transmitted from T3 to the outside may be assigned location information regarding the positions of the terminal devices T1, T2 and T3, respectively.

The load balancer 22 forwards the terminal message to at least one of the distribution systems 10a and 10b. At this time, the load balancer 22 may transmit the terminal message to at least one of the distribution systems 10a and 10b according to a predetermined setting. The predetermined setting may include selecting a distribution system close to the location of the terminal device. The predetermined setting may be stored in the load balancer 22 as a setting parameter.

The distribution system 10a includes a distribution control unit 11a and a distribution queue control unit 12a. In the memory of the distribution system 10a, at least some of the vehicles including the vehicle C1, C2 and C3 and connection state information 13a indicating the connection status with the distribution system 10a are stored. A distribution queue 14a is stored in an input/output memory (Input/Output Memory) of the distribution system 10a.

The distribution system 10b includes a distribution control unit 11b and a distribution queue control unit 12b. In the memory of the distribution system 10b, at least some of the vehicles including the vehicle C1, C2 and C3 and connection state information 13b indicating the connection status with the distribution system 10b are stored. A distribution queue 14b is stored in the input/output memory of the distribution system 10b.

The distribution control unit 11a and the distribution queue control unit 12a may be realized by an arithmetic unit of the distribution system 10a. Similarly, the distribution control unit 11b and the distribution queue control unit 12b may be realized by an arithmetic unit of the distribution system 10b. The arithmetic unit may include, for example, at least one of CPU (Central Processing Unit) and GPU (Graphics Processing Unit). The computing device may include, for example, at least one of FPGA (Field Programmable Gate Array) and TPU (Tensor Processing Unit).

Note that distribution system 10a and 10b memories are not limited to RAM (Random Access Memory) and may include nonvolatile memories. The non-volatile memory may include, for example, at least one of a flash memory, a hard disk drive, and a solid state drive. Note that the distribution queue 14a and 14b may be concepts including at least one of a software queue and a hardware queue.

For example, an operation of the communication system 1 when a vehicle message indicating a connection-request is transmitted from DCM 31 of the vehicle C1 will be described. DCM 31 transmits a vehicle message indicating the connection request to the load balancer 21. For example, the load balancer 21 may determine a distribution system that transmits (in other words, forwards) the vehicle message based on the location information assigned to the received vehicle message. Here, it is assumed that the vehicle message is forwarded to the distribution system 10a by the load balancer 21.

Upon receiving the vehicle message indicating the connection request, the distribution queue control unit 12a of the distribution system 10a processes the connection request (that is, the request for connecting DCM 31 to the distribution system 10a). At this time, the distribution queue control unit 12a may add the fact that DCM 31 (in other words, the vehicle C1) and the distribution system 10a are in a connected state to the connection state information 13a. For example, after processing the connection request, the distribution queue control unit 12a may transmit an answer message indicating an answer to the connection request to DCM 31 (in other words, the vehicle C1). It can be said that the reply message is a reply to the vehicle message indicating the connection request. Thus, the reply message may be referred to as a reply message.

For example, an operation of the communication system 1 when a vehicle message indicating a disconnection request is transmitted from DCM 31 of the vehicle C1 will be described. Here, it is assumed that DCM 31 (in other words, the vehicle C1) is connected to the distribution system 10a. DCM 31 transmits a vehicle message indicating the disconnection request to the load balancer 21. For example, the load balancer 21 forwards the received vehicle messaging to the distribution system 10a.

Upon receiving the vehicle message indicating the disconnection request, the distribution queue control unit 12a of the distribution system 10a processes the disconnection request (that is, the request for disconnecting DCM 31 from the distribution system 10a). At this time, the distribution queue control unit 12a may add the fact that DCM 31 (in other words, the vehicle C1) and the distribution system 10a are in an unconnected state to the connection state information 13a. Alternatively, the distribution-queue control unit 12a may delete the information related to DCM 31 from the connection state information 13a. For example, after processing the disconnection request, the distribution queue control unit 12a may transmit an answer message indicating an answer to the disconnection request to DCM 31 (in other words, the vehicle C1).

Next, for example, the operation of the communication system 1 when a terminal message is transmitted from the terminal device T1 to the vehicles 31 will be described. The terminal message may be assigned location information regarding the location of the terminal device T1. The terminal device T1 transmits a terminal message to the load balancer 22.

For example, the load balancer 22 may determine a distribution system that transmits (in other words, forwards) the terminal message based on the location information assigned to the received terminal message. Here, it is assumed that the above-described terminal message is transferred to the distribution system 10a by the load balancer 22.

The distribution system 10a having received the terminal message may transmit a duplicate of the received terminal message to the distribution system 10b. Consequently, both the distribution system 10a and 10b receive the terminal message transmitted from the terminal device T1.

The operation of each of the distribution system 10a and 10b will be described referring to the flow chart of FIG. 2. In FIG. 2, the distribution control unit 11a of the distribution system 10a receives a terminal message (for example, a terminal message from the terminal device T1) (S111). Next, the distribution control unit 11a acquires a distribution destination list of the terminal message from the received terminal message (S112). Next, the distribution control unit 11a instructs the distribution queue control unit 12a to transmit a terminal message to each queue of all distribution destinations based on the acquired distribution destination list (S113).

The distribution queue control unit 12a receives a terminal message (for example, a terminal message from the terminal device T1) (S121). Next, based on an instruction from the distribution control unit 11a, the distribution queue control unit 12a stores the terminal messages in the queues of all the distribution destinations included in the distribution queue 14a (S122). Here, a terminal message is stored in a queue of a DCM 31 (in other words, a vehicle C1) as a distribution destination.

Next, the distribution queue control unit 12a determines whether or not there is a distribution destination of the connection state among the distribution destinations based on the connection state information 13a (S123). In S123 process, when it is determined that there is a distribution destination in the connection state (S123: Yes), the distribution queue control unit 12a transmits a terminal message to the distribution destination in the connection state (S124). On the other hand, in S123 process, when it is determined that there is no connected delivery destination (S123: No), the distribution queue control unit 12a discards the terminal message stored in the queue (S125).

Similarly, in FIG. 2, the distribution control unit 11b of the distribution system 10b receives a terminal message (for example, a terminal message from the terminal device T1) (S111). Next, the distribution control unit 11b acquires a distribution destination list of the terminal message from the received terminal message (S112). Next, the distribution control unit 11b instructs the distribution queue control unit 12b to transmit a terminal message to each queue of all distribution destinations based on the acquired distribution destination list (S113).

The distribution queue control unit 12b receives a terminal message (for example, a terminal message from the terminal device T1) (S121). Next, based on an instruction from the distribution control unit 11b, the distribution queue control unit 12b stores the terminal messages in the queues of all the distribution destinations included in the distribution queue 14b (S122). Here, a terminal message is stored in a queue of a DCM 31 (in other words, a vehicle C1) as a distribution destination.

Next, the distribution queue control unit 12b determines whether or not there is a distribution destination of the connection state among the distribution destinations based on the connection state information 13b (S123). In S123 process, when it is determined that there is a distribution destination in the connection state (S123: Yes), the distribution queue control unit 12b transmits a terminal message to the distribution destination in the connection state (S124). On the other hand, in S123 process, when it is determined that there is no connected delivery destination (S123: No), the distribution queue control unit 12b discards the terminal message stored in the queue (S125).

For example, when DCM 31 (in other words, the vehicle C1) and the distribution system 10a are connected, it is determined in the process of S123 of FIG. 2 that there is a distribution destination (in this case, DCM 31) of the distribution queue control unit 12a of the distribution system 10a. Consequently, the distribution-queue control unit 12a transmits the terminal message from the terminal device T1 to DCM 31 (in other words, the vehicle C1). In the process of S123 of FIG. 2, the distribution queue control unit 12b of the distribution system 10b determines that there is no distribution destination in the connected state. Consequently, the distribution queue control unit 12b discards the terminal message from the terminal device T1.

### Technical Effect

For example, in order to improve the reliability of message delivery to vehicles, a plurality of servers (corresponding to the distribution system 10a and 10b of the present disclosure) may share information indicating a connected state. The connection state of the vehicle changes from moment to moment. Therefore, real-time update of information indicating a connection state shared between a plurality of servers is required. However, in order to update information shared between a plurality of servers in real time, complicated control is required.

In contrast, in the communication system 1, for example, a terminal message from the terminal device T1 is received by both the distribution system 10a and 10b. A terminal message is transmitted from one of the distribution systems 10a and 10b connected to the distribution destination (for example, a DCM 31 mounted on the vehicle C1). On the other hand, on the other hand, the terminal messaging is discarded on the other side of the distribution system 10a and 10b which are not connected to the distribution destination (for example, DCM 31 mounted on the vehicle C1).

For example, after the terminal message for the vehicle C1 is transmitted from the terminal device T1, the terminal message is transmitted from the other of the distribution system 10a and 10b connected to DCM 31 to the vehicle C1 equipped with DCM 31 even if the connection destination of the vehicle C1 equipped with DCM 31 changes from one of the distribution system 10a and 10b to the other of the distribution system 10a and 10b. As described above, in the communication system 1, it is possible to constantly communicate with vehicles (for example, at least one of the vehicles C1, C2 and C3) under relatively simple control of receiving terminal messages in both the distribution system 10a and 10b.

### Modified Examples

In the above-described embodiment, one of the distribution system 10a and 10b to which the load balancer 22 has forwarded the terminal message transmits a duplicate of the terminal message to the other of the distribution system 10a and 10b. However, the load balancer 22 may forward the terminal messaging to both the distribution system 10a and 10b.

Various aspects of the disclosure derived from the embodiments and modifications described above are described below.

A communication system according to an aspect of the disclosure includes a communication device mounted on a vehicle, a load balancer, and a plurality of distribution systems. The communication device transmits a vehicle message indicating a connection request to the load balancer. The load balancer determines whether to transfer the vehicle message to one distribution system of the plurality of distribution systems based on a setting parameter related to the vehicle message. If it is determined to transfer the vehicle message to the one distribution system, the one distribution system sends a reply message to the vehicle message. In the above-described embodiment, “DCM 31, 32, and 33” correspond to an exemplary “communication device”.

In the communication system, each of the plurality of distribution systems may be capable of transmitting a distribution message to the vehicle via the load balancer. Each of the plurality of distribution systems may store the delivery message. One distribution system connected to the vehicle through the communication device among the plurality of distribution systems may transmit the stored distribution message to the vehicle. In the above-described embodiment, the “terminal message” corresponds to an example of the “delivery message”.

In the communication system, one or more distribution systems that are not connected to the vehicle among the plurality of distribution systems may discard the stored distribution message.

In the communication system, the first distribution system among the plurality of distribution systems may transmit the distribution message to the second distribution system among the plurality of distribution systems. In the above-described embodiment, “one of the distribution systems 10a and 10b” corresponds to an example of the “first distribution system”, and “the other of the distribution system 10a and 10b” corresponds to an example of the “second distribution system”.

A communication system according to another aspect of the disclosure includes a plurality of distribution systems capable of transmitting a distribution message to a target vehicle, and a communication device mounted on the target vehicle. Each of the plurality of distribution systems stores the delivery message. One distribution system connected to the target vehicle through the communication device among the plurality of distribution systems transmits the stored distribution message to the target vehicle.

The present disclosure is not limited to the above-described embodiments, and can be modified as appropriate within the scope and spirit of the disclosure that can be read from the claims and the entire specification. Communication systems with such changes are also within the scope of the present disclosure.

What is claimed is:

1. A communication system comprising:
a communication device mounted on a vehicle;
a load balancer; and
a plurality of distribution systems, wherein
the communication device is configured to transmit a vehicle message indicating a connection request to the load balancer,
the load balancer is configured to determine whether to transfer the vehicle message to one distribution system out of the plurality of distribution systems based on a setting parameter related to the vehicle message, and
the one distribution system is configured to, when determination is made to transfer the vehicle message to the one distribution system, transmit a reply message to the vehicle message.

2. The communication system according to claim 1, wherein:
each of the distribution systems is configured to transmit a distribution message to the vehicle via the load balancer;
each of the distribution systems is configured to store the distribution message; and
one distribution system connected to the vehicle via the communication device out of the plurality of distribution systems is configured to transmit the stored distribution message to the vehicle.

3. The communication system according to claim 2, wherein one or more distribution systems that are not connected to the vehicle out of the plurality of distribution systems is configured to discard the stored distribution message.

4. The communication system according to claim 2, wherein a first distribution system out of the plurality of distribution systems is configured to transmit the distribution message to a second distribution system out of the plurality of distribution systems.
